(19) United States
(12) Patent Application Publication
(10) Pub. No.: US 2015/0021278 A1
(43) Pub. Date: Jan. 22, 2015

(54) APPARATUS FOR CONTINUOUS HYDROLYSIS

(71) Applicant: Veolia Water Solutions & Technologies Support, Saint Maurice Cedex (FR)

(72) Inventor: Soren Johannes Hojsgaard, Hillerod (DK)

(73) Assignee: Veolia Water Solutions & Technologies Support, Saint Maurice Cedex (FR)

(21) Appl. No.: 14/377,333

(22) PCT Filed: Feb. 8, 2013
(86) PCT No.: PCT/EP2013/052524

§ 371 Date: Aug. 7, 2014

(30) Foreign Application Priority Data
Feb. 8, 2012 (EP) 12154532.1

(51) Int. Cl. C02F 1/02; C02F 11/18

(52) U.S. Cl. CPC C02F 1/025; C02F 11/18; C02F 2201/003; C02F 2301/028; C02F 2303/06
USPC 210/750; 210/218; 210/177

(57) ABSTRACT

An apparatus for continuous hydrolysis of sludge comprising material of biological origin, such as organic material, the apparatus comprising a reactor with: an inlet for feeding sludge into the reactor in a feeding zone thereof, an inlet for feeding steam into the reactor in a steam feeding zone thereof, an outlet for allowing processed sludge to exit the reactor, wherein at least a part of the reactor forms a first ascending zone in which the sludge during use flows in an upwards direction, and a first descending zone in which the sludge during use flows in a downwards direction. A first gas collecting zone is defined in the transition between the first ascending zone and the first descending zone, and a first gas outlet is arranged to allow a part of the gas collected in the first gas collecting zone to be removed, while a part of the gas remains in the gas collecting zone.

This application is a U.S. National Stage Application of PCT Application No. PCT/EP2013/052524, with an international filing date of 8 Feb. 2013. Applicant claims priority based on EP Patent Application No. 12154532 filed 8 Feb. 2012. The subject matter of these applications is incorporated herein.

### FIELD OF THE INVENTION

The present invention relates to an apparatus for continuous hydrolysis of sludge comprising material of biological origin, such as organic material. In particular the present invention relates to an apparatus which is divided into one or more ascending zones and one or more descending zones.

### BACKGROUND OF THE INVENTION

In most parts of the world waste water from households, industrial processes and agriculture is mechanically, biologically and/or chemically treated prior to emission into streams, creeks and rivers. This is done in order to prevent contamination of said streams, creeks and rivers. Besides cleaned water such treatment processes result in production of amounts of sludge/waste containing organic material. Households, industrial processes and agriculture do also result in different residues and waste types containing organic material. The term sludge is in the following used for all such residues, sludge and waste types.

The mentioned sludge does normally need further treatment before it can be disposed of. Such treatment can be aerobic and/or anaerobic biological degrading wherein organic material is degraded. However certain organic material is harder to degrade than other. It is known to speed up the degrading process by heating the sludge, and maintaining it at a temperature of about 140-160 degrees Celsius for a predetermined period of time, such as for at least half an hour. Such a process is known as thermal hydrolysis and causes organic material which exhibits reluctance to biological degrading, to be turned into material which is easily degradable.

Thermal hydrolysis may be performed in a batch process in which batches of sludge are subjected to thermal hydrolysis and subsequently fed into a digester. Alternatively, the thermal hydrolysis may be performed continuously, as is described in EP 1 198 424 and WO 2009/121873.

DE 2 030 062 discloses a method and an apparatus for supplying steam to sludge in order to thermally condition the sludge.

Further background art may be found in WO 96/09882, WO 2006/027062, WO 92/06925 and WO 2004/096866.

It is an object of one or more embodiments of the present invention to provide a reactor in which it can be ensured that all the sludge is subjected to a predetermined minimum temperature for a predetermined period of time.

Moreover, it is an object of one or more embodiments of the present invention to provide a system for continuous thermal hydrolysis adapted to treat sludge with a dry solids content of at least 20%.

Furthermore, it is an object of one or more embodiments of the present invention to provide a system for continuous thermal hydrolysis in which no heat exchanger is needed to cool down the sludge.

### SUMMARY OF THE INVENTION

According to a first aspect, the present invention relates to an apparatus for continuous hydrolysis of sludge comprising material of biological origin, the apparatus comprising:
a reactor
an inlet for feeding sludge into the reactor in a feeding zone thereof,
an inlet for feeding steam into the apparatus in a steam feeding zone of the apparatus, and
an outlet for allowing processed sludge to exit the reactor,

wherein at least a part of the reactor forms a first ascending zone in which the sludge during use flows in an upwards direction, and a first descending zone in which the sludge during use flows in a downwards direction,

the apparatus further comprising:

a first gas collecting zone defined in the transition between the first ascending zone and the first descending zone, the first gas collecting zone comprising a first gas outlet which is arranged such that a part of the gas collected in the first gas collecting zone can be removed from the apparatus, via the gas outlet, and a part of the gas collected in the first gas collecting zone remains in the first gas collecting zone when the first gas outlet is opened.

The sludge may be cooled down by injecting cooling water, whereby the sludge is cooled down inside the apparatus and not along its inner surfaces. Accordingly in one embodiment, the apparatus for continuous hydrolysis comprises an inlet for feeding cooling water into the apparatus in a cooling zone thereof. In one embodiment, the inlet for feeding cooling water is provided in the reactor. In another embodiment, the inlet for feeding cooling water is provided downstream relative to the reactor.

In conventional systems, the sludge is cooled by means of a heat exchanger which is adapted to cool down one or more inner surfaces of the reactor, whereby the sludge contacting said surface(s) is/are cooled down. However as the inner surfaces are cooled down, the sludge positioned in the area of or contacting said colder inner surfaces will deposit the particles on said surfaces as the sludge is cooled below a certain temperature. The consequence is that such systems must be cleaned frequently in order to function properly.

Another advantage of the adding of cooling water is that the dry solids content of the sludge fed into the system may be higher, as the sludge is thinned at a point downstream relative to the sludge feeding inlet. Due to the higher level of dry solids content, the capacity of the system of the present invention is large relative to known systems comprising a heat exchanger for cooling the sludge to a temperature suitable for processing in a subsequent digester. However, in some embodiments a heat exchanger may be used, e.g. in combination with addition of cooling water. For instance, a supply of cooling water may be arranged downstream relative to a heat exchanger.

One advantage of supplying steam to the sludge is that the high temperature and the increased pressure may lead to desired chemical reactions, such as hydrolysis of long chain carbon molecules.

By providing a first ascending zone and a first descending zone it may be ensured that the sludge is maintained in the reactor for a predetermined period of time and at a predetermined temperature. It will be appreciated that any sludge which enters either of the ascending zone and the descending zone will be layered in the ascending zone depending on its density and buoyancy. Thus by providing the ascending and descending zones, predetermined retention times may be ensured. This provides the advantage that any particle in the sludge is treated in a predetermined way for a predetermined period of time.

The water fed into the system may be tap water and/or processed water e.g. treated waste water. Another example is waste water with a dry-solids content in a predetermined range such as in the range 0-5 percent, such as 0-10 percent, such as 0-20 percent. In one embodiment, the water is any kind of liquid which is suitable for cooling down the sludge. Such a suitable liquid may be any liquid which does not prevent any subsequent processing of the sludge. As an example, the liquid may be any liquid which does not damage the biological treatment provided downstream relative to the reactor.

Static or dynamic mixers may be provided in the area of or downstream the steam feeding zone or in the first ascending zone so as to improve the mixing of the steam and the sludge. One effect is that the temperature of the sludge becomes more uniform.

The steam feeding zone may be provided in the lower half of the first ascending zone, such as in the lower third, such as in the lower fourth, such as in the lower fifth. In one embodiment, the steam feeding zone is provided in the bottom of the first ascending zone.

In one embodiment, the height of the reactor is in the range of 1 to 50 meters, such as in the range of 5-50 meters, such as in the range of 1-10 meters, such as in the range of 10-40 meters, such as in the range 20-30 meters. In one embodiment the diameter of the tube reactor is in the range 50-5000 mm, such as in the range 100-4000 mm, such as in the range 200-1000, such as in the range 200-300 mm.

The pressure of the steam fed into the tube reactor may be above 2 Bar, such as above 5 Bar, such as above 10 Bar, such as above 15 Bar, or such as above 20 Bar. During use the pressure inside the reactor may be above 2 Bar, such as above 5 Bar, such as above 10 Bar, such as above 15 Bar, or such as above 20 Bar.

In one embodiment, the reactor is designed so as to allow the predetermined retention time to be above 5 minutes, such as above 20 minutes, such as above 30 minutes, such as above 45 minutes, such as above 60 minutes, such as above 90 minutes, such as above 180 minutes, or even longer.

In one embodiment, the first ascending zone is located upstream relative to the first descending zone, such that the sludge initially flows into the first ascending zone and subsequently into the first descending zone.

By providing a first ascending zone and a subsequent first descending zone it may be ensured that the sludge is maintained in the reactor for a predetermined period of time and at a predetermined temperature. It will be appreciated that any sludge which enters the ascending zone will be layered in the ascending zone depending on its buoyancy. When the content of the sludge is substantially homogenous throughout the reactor, the buoyancy is determined by the temperature of the sludge.

When the steam is fed into the reactor in the steam feeding zone, the thermal energy of the steam will gradually be transferred to those parts of the sludge, which are in contact with the steam. This causes the temperature of the steam to decrease while at the same time causing the temperature of the contacted sludge to increase. This will cause a relatively chaotic flow of the sludge in the first part of the reactor following the steam feeding zone. Once all of the free steam has been absorbed in the sludge, the flow of the sludge becomes more smooth. The heated sludge, with steam injected therein, moves upwards in the first ascending zone, partly due to new sludge being fed into the reactor, pushing the sludge upwards. However, the warmer sludge moves faster in the upwards direction than the cooler sludge, because the buoyancy of the warmer sludge is higher than the buoyancy of the cooler sludge. Therefore the warmer sludge reaches the end of the first ascending zone faster than the cooler sludge. When the sludge subsequently flows through the first descending zone, the cooler sludge will move faster through the first descending zone that the warmer sludge, due to the difference in buoyancy. Thus, the cooler sludge remains in the first ascending zone longer than the warmer sludge, and the warmer sludge remains in the first descending zone longer than the cooler sludge. Thereby it is ensured that all of the sludge remains in the reactor for a specified minimum time.

Accordingly, it is ensured that the sludge passing from the ascending zone to the descending zone will have reached a predetermined temperature. When the sludge has reached the descending zone it is forced to move downwards in the descending zone. This will be done at the predetermined temperature which was reached in the ascending zone and for a predetermined period of time. It will be appreciated that this predetermined period of time is determined by the volume of the descending zone and the amount of sludge passing though this volume.

In the context of the present invention the term “continuous thermal hydrolysis” shall be understood as a process wherein thermal hydrolysis is undertaken while new unprocessed sludge is fed into the system, and while at the same time processed sludge exits the system.

In the context of the present invention the term “sludge” shall be understood as any material of biological origin and which contains organic material. Examples are residuals and waste from households, kitchens, industrial processes and from processes related to agriculture/farming (including crops and residuals thereof, manure, residuals and waste from plant and vegetable processing industries, dairies, slaughterhouses and meat processing industries) and sludge obtained from treatment of wastewater from households, industries and/or agriculture/farming.

The sludge may contain dry solids of which at least a part is organic material, such as at least 10 percent organic material, such as at least 20 percent organic material, such as at least 40 percent organic material, such as at least 60 percent organic material, such as at least 80 percent organic material.

The reactor may define a generally longitudinal direction, a geometrical component of which may be parallel to a vertical direction. In one embodiment, the longitudinal direction of the reactor defines no geometrical component which is parallel to the horizontal direction. Thus, the longitudinal direction may be substantially vertical, even though a slight tilt of the longitudinal direction, relative to a vertical direction, may be allowed.

The reactor may define a tubular cross-section in a plane which is parallel to the horizontal direction. As is described in further detail below, the reactor may define one or more concentric walls which are arranged to separate and define one or more ascending and descending zones.

The reactor may be rotationally symmetric about a longitudinal axis. This may, e.g., be obtained by designing the reactor with a number of concentric, substantially cylindrical walls.

At least a first ascending zone and a first descending zone are provided. The two zones may be defined by providing an upwardly extending wall in a chamber whereby two neighbouring zones are defined. In one embodiment, the wall extends from a bottom of the chamber and towards—but not entirely up to—a ceiling or upper inner surface of the chamber. When the wall does not extend entirely up to the ceiling or upper inner surface of the chamber, a passage/space will be defined between the ceiling or upper inner surface of the chamber and the upper part (the top) of the wall. When the sludge flows from the ascending zone and into the descending zone, the sludge will pass through this passage/space.

During use, the sludge may flow upwards in the ascending zone, around the top of the wall and downwards in the descending zone. It will be appreciated that the inlet for feeding sludge may be defined in the lower part of the ascending zone and an outlet may be defined in the lower part of the descending zone.

Moreover, the inlet for feeding steam into the reactor may be provided in the lower part of the ascending zone such that the steam is allowed to pass from the lower part of the ascending zone and towards the upper part of the ascending zone. Alternatively, the inlet for feeding steam into the reactor may be provided in the apparatus upstream relative to the reactor, e.g. in a steam mixing chamber provided upstream relative to the reactor.

In one embodiment, the first descending zone—in one or any cross-section—encirculates the first ascending zone, such that the first ascending zone is provided inside the first descending zone. The wall separating the first ascending zone and the first descending zone may define a circular cross-section. Accordingly, the wall may define a tube which extends from a bottom of the reactor and in an upwards direction towards—but not entirely up to—the ceiling or upper inner surface of the reactor.

When the wall defines a circular cross-section, the first descending zone may define a ring-shaped cross-section in a plane which is transverse to a longitudinal direction of the first descending zone. The ring-shaped cross-section may be concentric with respect to the first ascending zone, which may form a tubular passage which extends in an upwards direction.

In one embodiment, one separating wall separates the first ascending zone and the first descending zone. The first separating wall may extend in an upwards direction from a lower part of the reactor, the first separating wall separating the first ascending zone and the first descending zone. Moreover, the first separating wall may thermally insulate the first ascending zone from the first descending zone. In one embodiment, the thermal conductivity of the wall is below 1 W/(m·K), such as below 0.8 W/(m·K), such as below 0.6 W/(m·K), such as below 0.4 W/(m·K), such as below 0.2 W/(m·K), such as below 0.05 W/(m·K), such as below 0.025 W/(m·K).

In order to provide this thermal insulation, the wall—or at least a part thereof—may comprise a thermally insulating material such as mineral wool or mineral fibres. It will be appreciated that by insulating the wall, the thermal energy from the first descending zone is not transferred to the relatively colder first ascending zone. Thus, the predetermined temperature may be maintained during the entire passage through the first descending zone and thus for the predetermined period of time during which the sludge travels through the first descending zone.

In another embodiment, the wall is not thermally insulated whereby a part of the thermal energy from the first descending zone is transferred—by thermal conduction through the wall—to, especially the lower part of, the first ascending zone due to the temperature difference between the two zones. Thereby a more uniform temperature of the sludge throughout the reactor is obtained, and it is easier to ensure and prove that all of the sludge is maintained above a specific temperature for a specific time. In the latter embodiment, a temperature sensor/gauge may be provided in the lower part of the first descending zone such that the temperature of the sludge leaving the first descending zone may be monitored. It will be appreciated that this temperature is the minimum temperature which the sludge has been subjected to during the predetermined period of time during which the sludge travels through the first descending zone.

In one embodiment, one or more temperature sensors/gauges may be provided in the lower part of the reactor e.g. where the sludge is fed into the reactor, such as in the vicinity of the sludge inlet. Alternatively, or as a supplement, one or more temperature sensors/gauges may be provided in the reactor where the sludge exits the reactor i.e. in the area of the sludge outlet. Alternatively or as a supplement, one or more temperature sensors/gauges may be provided downstream relative to the sludge outlet or upstream relative to the sludge inlet. In one embodiment, one or more temperature sensors/gauges are provided between the sludge inlet and the sludge outlet. As an example a temperature sensor may be provided in one transition between an ascending zone and a descending zone. In one embodiment, a temperature sensor/gauge may be provided in the transition between each ascending and descending zone.

In one embodiment, the amount of steam which is added in the steam feeding zone is controlled such that the sludge has a predetermined temperature when leaving the first descending zone, such that both a predetermined temperature and a predetermined period of time is ensured during operation of the reactor.

Depending on the content of the sludge, gas may be formed and/or contained in the sludge. Due to the geometry of the first ascending zone and the first descending zone, this gas may accumulate in the space defined in the transition between the first ascending zone and the first descending zone, as it cannot move downwards (against the buoyancy) in the flow direction of the descending zone. Thus, there is a need for removing this gas. Accordingly, a first gas collection zone is defined in the transition between the first ascending zone and the first descending zone. The lower part of the first gas collecting zone may correspond to the upper part of the first separating wall. In one embodiment, the first gas collecting zone is arranged such that gas ascending in the first ascending zone and the first descending zone is collected in the first gas collecting zone. In one embodiment, the first gas collecting zone is arranged above the first ascending zone and/or the first descending zone. In order to collect the gas, the reactor may define one or more surfaces which is/are arranged to guide the gas into the first gas collecting zone. As an example, inclined surfaces may be provided above the first ascending zone and/or the first descending zone.

It will be appreciated that it may be desirable to be able to remove at least a part of the gas from the first gas collecting zone so as to maintain a desired level of sludge. Thus, the first gas collecting zone comprises a first gas outlet which is arranged such that at least a part of the gas collected in the first gas collecting zone can be removed. This gas may be removed continuously or in batches during operation of the continuous thermal hydrolysis.

While it is desirable to remove some of the gas, it may also be desirable not to remove all the gas, as this gas during use will function like a resilient element, as the gas—contrary to the sludge—is compressible. Accordingly, the first gas outlet is shaped and arranged such that a predetermined amount of gas remains in the first gas collecting zone when the first gas outlet is opened. As an example the first gas outlet may be defined by a tube extending into the reactor from an upper surface (a ceiling) thereof and having an opening at its lower end through which the gas escapes the reactor. Thus, any gas provided above the opening cannot escape the reactor whereby a predetermined amount of gas may be ensured in the first gas collecting zone.

Accordingly when emptying a part of the gas, any gas provided below the opening is emptied through the outlet. During this process, the upper surface of the sludge will ascend towards the opening and, if the gas outlet remains open, flow into the tube. A sensor may be provided in the tube for determining presence of sludge. This sensor may be used to operate a valve which closes so as to prevent the sludge from flowing out of the reactor, through the first gas outlet. It should be noted, that prior to opening the gas outlet, it may be required to increase the pressure in the pipes receiving the gas from the gas collecting zone, to a level at or near the pressure inside the apparatus. This will be described in further detail below with reference to the figures.

The gas remaining in the first gas collecting zone, when the first gas outlet is opened, may be used for damping pressure variations inside the apparatus. Since liquids are incompressible, the sludge contained in the apparatus will not be compressed in response to pressure variations inside the apparatus, such as inside the reactor. However, contrary to liquids, gases are compressible. By allowing part of the gas collected in the first gas collecting zone to remain in the first gas collecting zone when the first gas outlet is opened, it is ensured that an amount of gas is present inside the apparatus. Thereby, in case of pressure variations inside the apparatus, the gas remaining in the first gas collecting zone will be able to compress and expand in response to the pressure variations, thereby damping the pressure variations inside the apparatus. Thus, the gas remaining in the first gas collecting zone acts similar to a ‘resilient element’ or a ‘spring’.

The first gas outlet may be arranged at a position between an upper surface of sludge contained in the apparatus and a wall defining an upper boundary of the first gas collecting zone. According to this embodiment, a head space is formed between the first gas outlet and the wall defining an upper boundary of the first gas collecting zone. The gas remaining in the apparatus will, in this case, primarily be the gas contained in this head space, while gas accommodated between the upper surface of the sludge and the level of the first gas outlet is at least partly removed from the apparatus when the first gas outlet is opened. The wall defining an upper boundary of the first gas collecting zone may, e.g. be or form part of a ceiling or top of the reactor or of a separate gas collecting tank.

For simplicity reasons the above description of the reactor only describes a first ascending zone and a first descending zone. However it will be appreciated that a plurality of ascending and descending zones may be provided. Thus, the above description relating to the first ascending and the first descending zones also applies when a plurality of ascending and descending zones are provided. As an example a plurality of ascending and descending zones may encircle each other such that the walls separating the zones define concentric rings.

Two ascending zones may be provided or three ascending zones or four ascending zones or five ascending zones. Additionally, two descending zones may be provided or three descending zones or four descending zones or five descending zones. It could also be envisaged that more than five ascending and/or descending zones may be provided.

The ascending zones may be arranged such that every other/second zone is an ascending zone while the remaining zones are descending zones. In one embodiment, the first zone which the sludge flows into is an ascending zone, while in another embodiment, the sludge initially flows into a descending zone. In one embodiment, the last zone which the sludge flows into is an ascending zone, while in another embodiment, the last zone which the sludge flows into is a descending zone. In one embodiment, the number of ascending zones is identical to the number of descending zones. In one embodiment, the number of ascending zones corresponds to the number of descending zones plus one. In one embodiment, the number of descending zones corresponds to the number of ascending zones plus one.

In one embodiment, at least a part of the reactor forms a second ascending zone in which the sludge during use flows in an upwards direction, and a second descending zone in which the sludge during use flows in a downwards direction, wherein the second ascending zone is located downstream relative to the first descending zone and upstream relative to the second descending zone. Accordingly in the latter embodiment, the order of the zones in the flow direction of the sludge is as follows: first ascending zone—first descending zone—second ascending zone—second descending zone. The zones may be provided in a concentric configuration in which the first ascending zone is encircled by the first descending zone, the second ascending zone, and the second descending zone. Moreover, in the latter embodiment, the first descending zone may be encircled by the second ascending zone, and the second descending zone, and the second ascending zone may be encircled by the second descending zone.

In another embodiment, the order of the zones in the flow direction of the sludge is as follows: first descending zone—first ascending zone—second descending zone—second ascending zone.

As is described above, the transition between the first ascending zone and the first descending zone, the two zones may be divided by a first upwardly extending wall which extends from a bottom and towards the ceiling without contacting this ceiling. Similarly, the transition between the first descending zone and the second ascending zone may be defined by a downwardly extending wall which extends from the ceiling of the reactor and towards—but not entirely into contact with—the bottom of the reactor.

The inlet for feeding cooling water and the outlet may be positioned downstream relative to the first and/or the second descending zone and/or a third descending zone and/or a fourth descending zone or any other descending zone. The cooling water may be supplied at only one location, via a single inlet. As an alternative, two or more inlets for feeding cooling water may be provided at separate positions.

The apparatus may further comprise a solid items outlet for removing solid items from the sludge. The solid items being removed via the solid items outlet may, e.g., be solid items having a relatively low density, e.g. cotton buds and/or other non-biodegradable items which it is desirable to remove from the apparatus. Furthermore, sludge having a low density, e.g. fat, may also be removed from the apparatus via the solid items outlet.

Items or sludge having a relatively low density will tend to float in an upper part of the sludge. Accordingly, such items tend to accumulate at the transition between the first ascending zone and the first descending zone. The items may therefore easily be removed from the apparatus via a solid items outlet arranged at or near this region.

The solid items outlet may be arranged at or near the first gas collecting zone. According to this embodiment, it may be possible to remove gas as well as solid items via the solid items outlet. For instance, when the solid items outlet is opened, gas may initially be removed via the solid items outlet until the pressure inside the apparatus has been reduced sufficiently to move the upper surface of the sludge to a level where the solid items outlet is arranged. Then solid items and/or sludge having a relatively low density is/are removed from the apparatus via the solid items outlet.

The abovementioned apparatus for thermal hydrolysis may be operated by means of the following method:
feeding the sludge into a feeding zone of the reactor, so as to increase the pressure and allow a temperature above 100 degrees Celsius without boiling of the sludge;
feeding steam into the reactor in a steam feeding zone, so as to increase the temperature to a temperature above 100 degrees Celsius;
maintaining the sludge in the reactor for a predetermined period of time,
feeding water into the reactor in a cooling zone so as to decrease the temperature to a temperature below 100 degrees Celsius, and
outputting the sludge in an outputting zone.

One advantage of this method of using the apparatus according to the present invention is that no or little depositing of substances such as vivianite and/or struvite, occur. Such depositing normally occur when the biological material is cooled down to an extent causing the concentration of a given chemical substance to be supersaturated due to solubility decreasing with decreasing temperature. Super-saturation will normally result in depositing an amount of the chemical substance sufficient to cause the substance reach its new saturation level.

In one embodiment water is fed into the reactor in the cooling zone so as to fulfil at least one of:
decreasing the temperature of the biological material to a temperature below 100 degrees Celsius, and
achieving a desired dry solids content of the treated biological material.

In one embodiment, the water is fed into the cooling zone so as to dilute the concentration in order to achieve a predetermined dry solids content which is suitable for the subsequent treatment in the digester. Such a predetermined dry solids content may be a dry solids content below 30%, such as below 20%, such as below 15%, such as below 12%, such as below 9%, such as below 6%. It will be appreciated that the ideal dry solids content of the sludge depends on the subsequent digester and that the dry solids content in most embodiments must be chosen such that the risk of ammonia inhibition of the digester is avoided.

In one predetermined embodiment, cooling water is fed into the cooling zone so as to dilute the biological material to a lower dry solids content.

It should be noted that the addition of steam in the steam feeding zone also causes the dry solids content level/percentage to drop relative to the level/percentage of the biological material which is fed into the reactor or the apparatus at the feeding zone.

In one embodiment the cooling water is fed into the cooling zone so as to decrease the temperature to a temperature below 120 degrees Celsius, such as below 100 degrees Celsius, such as below 80 degrees Celsius, such as below 60 degrees Celsius, such as below 50 degrees Celsius, such as below 40 degrees Celsius.

The water fed into the cooling zone may be in the range of 1 to 100 degrees Celsius, such as in the range of 10 to 50 degrees Celsius. The water fed into the system may be tap water and/or processed water e.g. treated waste water or water containing a dry-solids content of 0-10 percent, such as 0-5 percent

In one embodiment, the sludge is continuously fed from the feeding zone to the output zone via the steam feeding zone and the cooling zone.

In one embodiment the reactor is designed and controlled such that a predetermined period of time elapses when the sludge is fed from the steam feeding zone to the cooling zone. The predetermined time may be at least 10 minutes, such as at least 20 minutes, such as at least 30 minutes, such as at least 45 minutes, such as at least 60 minutes. In one embodiment, the predetermined time may be in the range of 20 to 120 minutes, such as in the range of 30 to 60 minutes.

The system may comprise a controller for controlling one or more of the feeding speed, the pressure within the reactor, the temperature and the pressure of the steam fed into the system, the temperature and the pressure of the cooling water fed into the system so as to cool down the sludge.

In one particular embodiment, the amount of injected steam is adjusted to the incoming flow of waste material/sludge, such that the desired temperature is obtained.

As mentioned previously, the present invention provides a system wherein sludge with a large content of dry solids may be fed into the system, e.g. such that the sludge provides a dry solids content of 1-50percent, such an 10-40 percent in the sludge fed into the feeding zone. In another embodiment, the organic material defines at least 20 percent of the sludge, such as at least 25 percent, such as at least 30 percent, such as at least 35 percent, such as at least 40 percent.

In one embodiment, the inlet for feeding steam into the apparatus is arranged to feed steam directly into the reactor, such as directly into the first ascending zone. In another embodiment, the inlet for feeding steam into the apparatus is arranged to feed steam into the flow of sludge before the sludge enters the reactor. In this case, the inlet for feeding steam into the apparatus may be arranged in a pipe leading sludge to the reactor.

According to a second aspect the invention provides a method for operating an apparatus for continuous hydrolysis of sludge comprising material of biological origin, the method comprising the steps of:
feeding sludge into a feeding zone of a reactor,
feeding steam into a steam feeding zone of the apparatus, thereby injecting steam into the sludge,
passing the sludge, in an upwards direction, through a first ascending zone,
passing the sludge, in a downwards direction, through a first descending zone,
collecting gas in a first gas collecting zone defined in the transition between the first ascending zone and the first descending zone, and
removing a part of the gas collected in the first gas collecting zone, via a first gas outlet, while allowing a part of the gas collected in the first gas collecting zone to remain in the first gas collecting zone.

It should be noted that a person skilled in the art would readily recognise that any feature described in combination with the first aspect of the invention could also be combined with the second aspect of the invention, and vice versa. The remarks set forth above with reference to the first aspect of the invention are therefore equally applicable here. In particular, the method according to the second aspect of the invention could suitably be used for operating an apparatus according to the first aspect of the invention.

The method may further comprise the step of damping pressure variations inside the apparatus by means of the gas remaining in the first gas collecting zone. As described above, this is possible because gasses, contrary to liquids, are compressible, and the gas remaining in the first gas collecting zone is therefore able to compress and expand in response to pressure variations inside the apparatus, thereby damping these pressure variations.

The method may further comprise the step of removing solid items from the sludge, via a solid items outlet. As described above, solid items having a relatively low density as well as sludge having a low density may be removed from the apparatus via the solid items outlet.

The method may further comprise the step of passing the sludge, in an upwards direction, through a second ascending zone. According to this embodiment, the sludge is initially moved in an upwards direction, in the first ascending zone, then in a downwards direction, in the first descending zone, and then in an upwards direction, in the second ascending zone. Thus, the direction of movement is changed twice. It should be noted that the method may further comprise the steps of passing the sludge through a second, third, fourth, etc. descending zone, and through a third, fourth, etc. ascending zone, the ascending and descending zones being arranged in an alternating manner.

### BRIEF DESCRIPTION OF THE FIGURES

The invention will now be described in further detail with reference to the figures in which:

FIG. 1 discloses a cross section of a reactor for an apparatus according to a first embodiment of the invention, and

FIG. 2 discloses a cross section of a reactor for an apparatus according to a second embodiment of the invention.

### DETAILED DESCRIPTION OF THE FIGURES

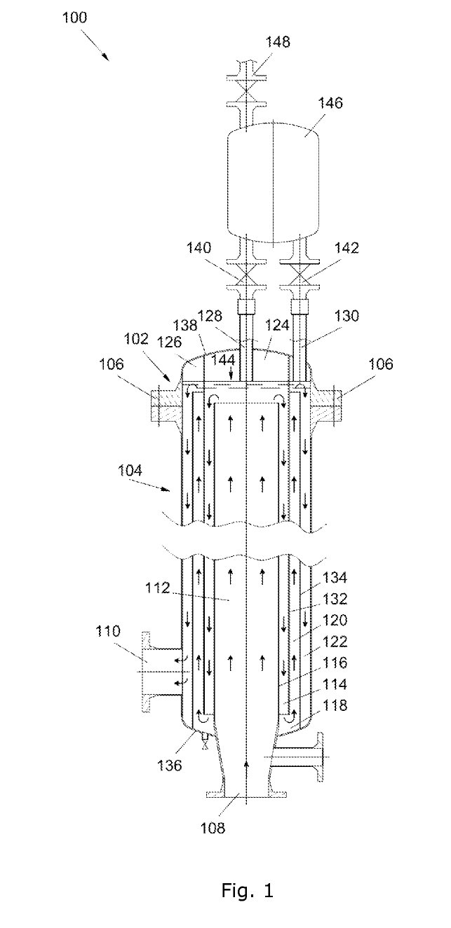

FIG. 1 discloses a reactor 100 for an apparatus according to a first embodiment of the invention. The reactor 100 comprises an upper reactor part 102 and a lower reactor part 104. The upper reactor part 102 and the lower reactor part 104 are joined together in the area of the flanges 106 which are fastened together by means of bolts (not shown). The reactor 100 defines a sludge inlet 108 through which the sludge is fed into the reactor 100 and a sludge outlet 110 through which the treated sludge exits the reactor 100. Once the sludge has entered reactor 100 through the sludge inlet 108, it flows into a first ascending zone 112.

In the area of the sludge inlet 108, means for injecting steam may be provided so as to raise the temperature from an initial temperature below 100 degrees Celsius to a temperature above 100 degrees Celsius. The means for injecting steam into the sludge may be provided in the reactor or may be provided upstream relative to the reactor.

The effect of injecting steam into the sludge is that the steam ascends in the first ascending zone 112 whereby any sludge contacting the steam is heated. As a consequence, the sludge in the first ascending zone 112 will be layered depending on its temperature as the relatively cold sludge has a lower buoyancy compared to relatively hot sludge. Thus, the cold and unheated sludge will remain in the lower part of the first ascending zone 112, while the heated sludge will flow towards in the upper part of the first ascending zone 112. It will however be appreciated that due the flow of the sludge fed into the first ascending zone 112, even a part of the sludge which has a temperature below 100 degrees Celsius will be moved into the first descending zone 114. The reason for this is that the resulting force acting on the sludge in the upwards direction is a combination of the force of the buoyancy and the force of the inflowing sludge which pushes the remaining sludge in the upwards direction.

As a result, only sludge which has reached a predetermined temperature flows from the upper part of the first ascending zone 112 to the upper part of a first descending zone 114. In this zone, the sludge will gradually flow towards the bottom 118 of the first descending zone 114. Depending on the degree of thermal insulating in the upwardly extending first separating wall 116 (which separates the first ascending zone 112 and the first descending zone 114), the temperature of the sludge in the first descending zone 114 will remain constant, or be slightly cooled during the process of descending towards the bottom 118. In the description of FIG. 1, it is assumed that the separating walls are insulated such that minimal transfer of thermal energy between the ascending and descending zones is ensured (however as is described elsewhere the walls may in other embodiments be non-insulated). Subsequently, the sludge will ascend in a second ascending zone 120 and subsequently descend in the second descending zone 122. From the second descending zone 122, the sludge leaves the reactor 100 through the sludge outlet 110. In the area of this sludge outlet 110 means for injecting cooling water may be provided so as to decrease the temperature of the treated sludge. However such means is/are not disclosed in FIG. 1. The means for injecting the cooling water may be provided inside the reactor 100 e.g.

close to the sludge outlet 110. Alternatively, or as a supplement, the means for injecting the cooling water into the sludge may be provided downstream relative to the reactor 100, e.g. in a cooling chamber provided subsequent to the reactor 100.

In order to define the first ascending zone 112, the first descending zone 114, the second ascending zone 120 and the second descending zone 122, first separating wall 116, second separating wall 132 and third separating wall 134 are provided. The first separating wall 116 is provided between the first ascending zone 112 and the first descending zone 114. The second separating wall 132 is provided between the first descending zone 114 and the second ascending zone 120. The third separating wall 134 is provided between the second ascending zone 120 and the second descending zone 122. None of the separating walls 116,132,134 extend entirely from the bottom 136 to the ceiling 138 of the reactor 100. Accordingly, the first separating wall 116 and the third separating wall 134 are free to expand in an upwards direction in response to an increasing temperature and the second separating wall 132 is free to expand in a downwards direction in response to an increasing temperature.

Any gas in the reactor 100 will ascend into a first gas collecting zone 124 or into a second gas collecting zone 126 where the gas due to its compressibility will function like a compressible spring, thus allowing for variations in the volume of the sludge and the pressure in the reactor 100. In order to be able to control the amount of gas in the first gas collecting zone 124 and the second gas collecting zone 126, first gas outlet 128 and second gas outlet 130 are provided. When the amount of gas is too high, a part of the gas may be removed by opening the first valve 140 and/or the second valve 142. The effect is that the upper surface 144 of the sludge ascends towards the opening of the first gas outlet 128 and/or the second gas outlet 130, depending on which of the valves 140,142 are open. In other words, if the first and second valves 140,142 are not opened simultaneously, the sludge level in the first and second zones 124,126 will be different depending on which of the two valves 140,142 is opened. If the first valve 140 is opened, then the water level will decrease in the first zone 124, and vice versa. It will be appreciated that other ways of releasing the incondensable gasses may be provided.

A part of the sludge may flow into the gas ventilation chamber 146 before the valves 140,142 are closed. Once the valves 140,142 are closed the exit valve 148 is opened and the gas leaves the gas ventilation chamber 146 while any sludge remains in the gas ventilation chamber 146. Subsequently, the exit valve 148 is closed, and the valves 140,142 are opened the next time gas must be removed from the reactor 100. When the latter happens, the sludge in the gas ventilation chamber 146 flows back into the reactor and gas passes up into the gas ventilation chamber 146. Subsequently, the above-mentioned ventilation process is repeated. It will be appreciated that the longer the first and second gas outlets 128,130 extend down into the reactor 100, the larger is the volume of the first and second gas collecting zones 124,126.

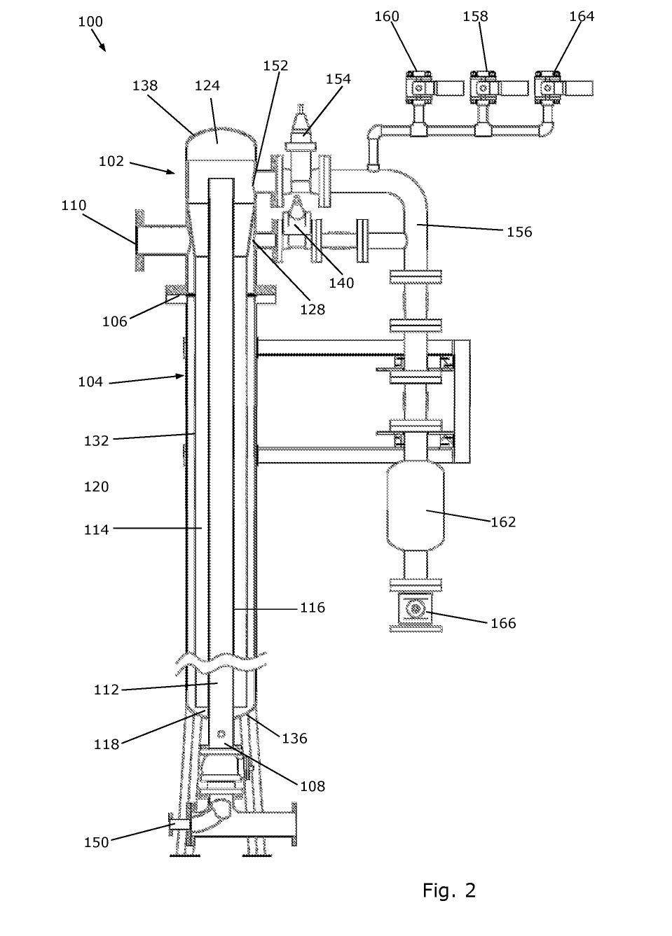

FIG. 2 is a cross sectional view of a reactor 100 for an apparatus according to a second embodiment of the invention. The reactor 100 of FIG. 2 is very similar to the reactor 1 of FIG. 1, and it will therefore not be described in detail here.

The reactor 100 of FIG. 2 only defines a first ascending zone 112, a first descending zone 114 and a second ascending zone 120, separated by first separating wall 116 and second separating wall 132. Thus, the second descending zone of the reactor of FIG. 1 is not present in the reactor 100 of FIG. 2. As a consequence, in FIG. 2, the sludge outlet 110 is arranged in the upper reactor part 102.

The reactor 100 of FIG. 2 comprises a steam inlet 150 arranged to supply steam to the sludge immediately before the sludge enters the first ascending zone 112 of the reactor 100. Thus, steam has been injected into the sludge which enters the reactor 100.

A solid items outlet 152 is arranged in the upper reactor part 102, in order to allow solid items having a low density to be removed from the sludge. Such items could, e.g., include cotton buds and/or other non-biodegradable items which it is desirable to remove from the sludge. Alternatively or additionally, the solid items could include fat or other biodegradable items which have a low density, and therefore have difficulties in moving downwards in the first descending zone 114. Solid items having a low density tend to have relatively high buoyancy, and therefore such items tend to float on top of the sludge having a higher density. Thereby these solid items may accumulate at the transition between the first ascending zone 112 and the first descending zone 114. The solid items outlet 152 is arranged exactly in the region where the solid items having a low density are expected to accumulate, and the solid items can therefore easily be removed via the solid items outlet 152.

A solid items valve 154 is arranged to control a flow through the solid items outlet 152. The apparatus may be operated in the following manner. When it is desired to remove solid items and/or incondensable gasses from the reactor 100, it is first investigated whether or not the pressure inside the reactor 100 and the pressure in pipe 156 are substantially equal. If this is not the case, valve 158 is opened in order to lead nitrogen gas into the pipe 156, thereby increasing the pressure inside the pipe 156 to a level at or near the pressure inside the reactor 100. Then valve 158 is closed.

Next, solid item valve 154 is opened, and subsequently valve 160 is slowly opened, thereby opening a fluid passage to a biogas facility or storage tank. This lowers the pressure in pipe 156 slightly and causes incondensable gasses to flow from the reactor 100 into the pipe 156.

Furthermore, this will increase the sludge level inside the reactor 100 until the sludge reaches the level of the solid items outlet 152. Then sludge and solid items having a low density will pass through the solid items outlet 152, into the pipe 156 and further on to solid item collection tank 162.

When the amount of solid items and sludge collected in the solid items collection tank 162 is sufficiently high, e.g. when the solid items collection tank 162 is approximately half full, the solid items valve 154 is closed. Then valve 164 is opened in order to lead water into the pipe 156 and the solid items collection tank 162, thereby cooling the sludge and the solid items collected there.

When the sludge and the solid items collected in the solid items collection tank 162 have reached a sufficiently low temperature, valve 166 is opened in order to remove the collected sludge and solid items from the solid items collecting tank 162. Finally, valve 164 may be opened once again in order to flush the pipe 156 and the solid items collection tank 162, before the valve 166 is once again closed, and the process may be repeated. Thus, the undesired solid items can easily be removed from the sludge.

Incondensable gasses may further be removed from the reactor 100 via first gas outlet 128, essentially in the manner described above with reference to FIG. 1.

1-20. (canceled)

21. An apparatus for continuous hydrolysis of sludge comprising material of biological origin, the apparatus comprising:
a reactor
an inlet for feeding sludge into the reactor in a feeding zone thereof,
an inlet for feeding steam into the apparatus in a steam feeding zone of the apparatus, thereby injecting steam into the sludge,
an outlet for allowing processed sludge to exit the reactor,
wherein at least a part of the reactor forms a first ascending zone in which the sludge during use flows in an upwards direction, and a first descending zone in which the sludge during use flows in a downwards direction,
the apparatus further comprising:
a first gas collecting zone defined in a transition between the first ascending zone and the first descending zone, the first gas collecting zone comprising a first gas outlet which is arranged such that a part of the gas collected in the first gas collecting zone can be removed from the apparatus, via the gas outlet, and a part of the gas collected in the first gas collecting zone remains in the first gas collecting zone when the first gas outlet is opened.

22. An apparatus according to claim 21, further comprising an inlet for feeding cooling water into the apparatus in a cooling zone thereof.

23. An apparatus according to claim 22, wherein the inlet for feeding cooling water and the outlet are positioned downstream relative to the first or the second descending zone.

24. An apparatus according to claim 21, wherein the first ascending zone is located upstream relative to the first descending zone.

25. An apparatus according to claim 21, wherein the first descending zone encircles the first ascending zone.

26. An apparatus according to claim 21, wherein the first descending zone defines a ring-shaped cross-section in a plane which is transverse to a longitudinal direction of the first descending zone, and wherein the ring-shaped cross-section is concentric with respect to the first ascending zone.

27. An apparatus according to claim 21, wherein one separating wall separates the first ascending zone and the first descending zone.

28. An apparatus according to claim 21, wherein the reactor defines a first separating wall which extends in an upwards direction from a lower part of the reactor, the first separating wall separating the first ascending zone and the first descending zone.

29. An apparatus according to claim 27, wherein the first separating wall thermally insulates the first ascending zone from the first descending zone.

30. An apparatus according to claim 21, wherein the first gas collecting zone is arranged such that gas ascending in the first ascending zone and the first descending zone is collected in the first gas collecting zone.

31. An apparatus according to claim 21, wherein the gas remaining in the first gas collecting zone, when the first gas outlet is opened, is used for damping pressure variations inside the apparatus.

32. An apparatus according to claim 21, wherein the first gas outlet is arranged at a position between an upper surface of sludge contained in the apparatus and a wall defining an upper boundary of the first gas collecting zone.

33. An apparatus according to claim 21, wherein at least a part of the reactor forms a second ascending zone in which the sludge flows in an upwards direction, and a second descending zone in which the sludge flows in a downwards direction, and wherein the second ascending zone is located downstream relative to the first descending zone and upstream relative to the second descending zone.

34. An apparatus according to claim 21, wherein the inlet for feeding steam into the apparatus is arranged to feed steam directly into the first ascending zone.

35. An apparatus according to claim 21, further comprising a solid items outlet for removing solid items from the sludge.

36. An apparatus according to claim 35, wherein the solid items outlet is arranged at or near the first gas collecting zone.

37. A method for operating an apparatus for continuous hydrolysis of sludge comprising material of biological origin, the method comprising the steps of:
feeding sludge into a feeding zone of a reactor,
feeding steam into a steam feeding zone of the apparatus, and injecting steam into the sludge,
passing the sludge, in an upwards direction, through a first ascending zone,
passing the sludge, in a downwards direction, through a first descending zone,
collecting gas in a first gas collecting zone defined in the transition between the first ascending zone and the first descending zone, and
removing at least a part of the gas collected in the first gas collecting zone, via a first gas outlet, while allowing a part of the gas collected in the first gas collecting zone to remain in the first gas collecting zone.

38. A method according to claim 37, further comprising the step of damping pressure variations inside the apparatus by means of the gas remaining in the first gas collecting zone.

39. A method according to claim 37, further comprising the step of removing solid items from the sludge, via a solid items outlet.

40. A method according to claim 37, further comprising the step of passing the sludge, in an upwards direction, through a second ascending zone.

41. An apparatus according to claim 21, further comprising:
an inlet for feeding cooling water into the apparatus in a cooling zone thereof;
wherein the inlet for feeding cooling water and the outlet are positioned downstream relative to the first or the second descending zone; and
wherein the first ascending zone is located upstream relative to the first descending zone.

42. An apparatus according to claim 41, wherein the first descending zone encircles the first ascending zone.

43. An apparatus according to claim 42, wherein the first descending zone defines a ring-shaped cross-section in a plane which is transverse to a longitudinal direction of the first descending zone, and wherein the ring-shaped cross-section is concentric with respect to the first ascending zone.
